(19) United States
(12) Patent Application Publication
(10) Pub. No.: US 2017/0263936 A1
(43) Pub. Date: Sep. 14, 2017

(54) LITHIUM METAL ELECTRODE, METHOD FOR PREPARING THE SAME, AND LITHIUM RECHARGEABLE BATTERY USING THE SAME

(71) Applicants: JIANGSU UNIONENERGY LITHIUM SULFUR BATTERY TECHNOLOGY CO., LTD., Suzhou (CN); JIANGSU HUADONG INSTITUTE OF LI-ION BATTERY CO., LTD., Suzhou (CN); TSINGHUA UNIVERSITY, Beijing (CN)

(72) Inventors: Peng Zhao, Beijing (CN); Li Wang, Beijing (CN); Xiang-Ming He, Beijing (CN); Jian-Jun Li, Beijing (CN); Yu-Ming Shang, Beijing (CN); Ju-Ping Yang, Beijing (CN); Jiang Cao, Beijing (CN); Yu-Feng Zhang, Beijing (CN); Jian Gao, Beijing (CN); Yao-Wu Wang, Beijing (CN)

(73) Assignees: JIANGSU UNIONENERGY LITHIUM SULFUR BATTERY TECHNOLOGY CO., LTD., Suzhou (CN); JIANGSU HUADONG INSTITUTE OF LI-ION BATTERY CO., LTD., Suzhou (CN); TSINGHUA UNIVERSITY, Beijing (CN)

(21) Appl. No.: 15/603,164

(22) Filed: May 23, 2017

Related U.S. Application Data
(63) Continuation of application No. PCT/CN2015/093464, filed on Oct. 30, 2015.

(30) Foreign Application Priority Data
Nov. 25, 2014 (CN) 201410686114.6

(51) Int. Cl. H01M 4/62; H01M 4/36; H01M 4/38; H01M 4/1395; C09D 151/10; H01M 10/0525; C08F 130/08; C09D 143/04; C08F 292/00; H01M 4/134; H01M 4/04

(52) U.S. Cl. CPC H01M 4/62; H01M 4/134; H01M 4/366; H01M 4/382; H01M 4/1395; H01M 4/0402; H01M 10/0525; C08F 130/08; C09D 143/04; C08F 292/00; C09D 151/10

(57) ABSTRACT

A lithium metal electrode includes a lithium metal plate and a protective layer coated on a surface of the lithium metal plate. The protective layer includes an organic-inorganic hybrid polymer comprising a repeating unit. The repeating unit includes a silicon atom, a methacryloyloxy group or an acryloyloxy group, and at least two alkoxy groups. The alkoxy groups and the methacryloyloxy group or the acryloyloxy group are respectively joined to the silicon atom. A method for preparing the lithium metal electrode and a lithium ion battery is also disclosed.

### CROSS-REFERENCE TO RELATED APPLICATIONS

This application claims all benefits accruing under 35 U.S.C. §119 from China Patent Application No. 201410686114.6, filed on Nov. 25, 2014 in the State Intellectual Property Office of China, the content of which is hereby incorporated by reference. This application is a continuation under 35 U.S.C. §120 of international patent application PCT/CN2015/093464 filed on Oct. 30, 2015, the content of which is also hereby incorporated by reference.

### FIELD

The present disclosure relates to batteries, and more particularly relates to electrodes, methods for preparing the same, and lithium rechargeable batteries using the same.

### BACKGROUND

Demands for ultra-thin and miniaturized electrical appliances grow with the development of science and technology, which require high specific energy batteries. The conventional anode material, graphite, has a theoretical specific capacity of 372 mAh/g and a great irreversible capacity loss in the first charge and discharge cycle. The researches on other high-energy anode materials currently have limited progress. The lithium metal has a high theoretical specific capacity (3860 mAh/g), a high exchange current density, and a small polarization.

### SUMMARY

One aspect of the present disclosure is to provide a lithium metal electrode, a method for preparing the same, and a lithium rechargeable battery using the same to suppress a growth of lithium dendrites.

The lithium metal electrode comprises a lithium metal plate and a protective layer coated on a surface of the lithium metal plate. A material of the protective layer is an organic-inorganic hybrid polymer. Each repeating unit of the organic-inorganic hybrid polymer comprises a silicon atom, a methacryloyloxy group or an acryloyloxy group, and at least two alkoxy groups. The alkoxy groups and the methacryloyloxy group or the acryloyloxy group are respectively joined to the silicon atom.

The method for preparing the lithium metal electrode comprises:
providing a lithium metal plate and an organic-inorganic hybrid polymer, wherein each repeating unit of the organic-inorganic hybrid polymer comprises a silicon atom, a methacryloyloxy group or an acryloyloxy group, and at least two alkoxy groups, and the alkoxy groups and the methacryloyloxy group or the acryloyloxy group are respectively joined to the silicon atom; and
coating the organic-inorganic hybrid polymer on a surface of the lithium metal plate to form a protective layer.

The lithium rechargeable battery comprises a cathode electrode, an anode electrode, a separator, and a non-aqueous electrolyte, wherein the separator is disposed between the cathode electrode and the anode electrode, the anode electrode is the lithium metal electrode.

The growth of the lithium dendrites commonly occurs in the charge and discharge of the conventional lithium metal electrode. If the lithium dendrites grow to a micron level and detach from the lithium metal plate, they could become “dead” lithium, resulting in a capacity decrease. If the lithium dendrites further grow, they could pierce the separator and extend to the cathode electrode, resulting in internal short circuit.

An aspect of the present disclosure has a lithium metal plate coated with a protective layer to suppress the production of the lithium dendrites and reduce side effects on the electrode surface, thereby greatly improving the electrochemical cycling stability of the battery.

### BRIEF DESCRIPTION OF THE DRAWINGS

Implementations are described by way of example only with reference to the attached figures.

FIG. 1 is a schematic structural view of one embodiment of a lithium metal electrode.

FIG. 2A and FIG. 2B are graphs showing electrochemical cycling curves of lithium rechargeable batteries in Example 1 and Comparative Example.

FIG. 3A and FIG. 3B are scanning electron microscope (SEM) images of the lithium metal electrodes after electrochemical cycling in Example 1 and Comparative Example.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

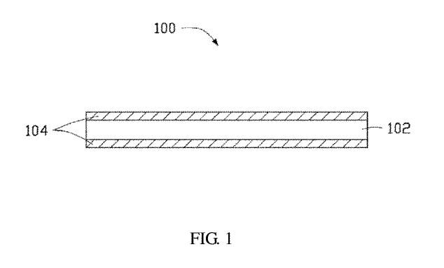

Referring to FIG. 1, one embodiment of a lithium metal electrode 100 comprises a lithium metal plate 102 and a protective layer 104 coated on a surface of the lithium metal plate 102. A material of the protective layer 104 is an organic-inorganic hybrid polymer. Each repeating unit of the organic-inorganic hybrid polymer comprises a silicon atom, a methacryloyloxy group or an acryloyloxy group, and at least two alkoxy groups. The alkoxy groups and the methacryloyloxy group or the acryloyloxy group are respectively joined to the silicon atom.

An amount of the repeating units in the organic-inorganic hybrid polymer can be about 40 to about 5000. The organic-inorganic hybrid polymer can be at least one of poly-γ-(triethoxysilyl)propyl methacrylate, poly-γ-(trimethoxysilyl)propyl methacrylate, poly-γ-methacryloxypropylmethyldimethoxysilane, poly-(diethoxymethylsilyl)propyl methacrylate, poly-γ-acryloxypropyltriethoxysilane, poly-γ-acryloxypropyltrimethoxysilane, poly-γ-acryloxypropylmethyldimethoxysilane, poly-acryloxypropylmethyldiethoxysilane, and poly-acryloxypropylmethyldimethoxysilane.

The lithium metal plate 102 can be a pure lithium metal, which can be used as the conventional anode electrode of the lithium rechargeable battery. A size of the lithium metal plate 102 is determined by a size of the lithium rechargeable battery. The protective layer 104 can be coated on the entire surface of the lithium metal plate 102.

One embodiment of a method for preparing the lithium metal electrode 100 comprises:

S1, providing the lithium metal plate 102 and the organic-inorganic hybrid polymer, wherein each repeating unit of the organic-inorganic hybrid polymer comprises a silicon atom, a methacryloyloxy group or an acryloyloxy group, and at least two alkoxy groups, and the alkoxy groups and the methacryloyloxy group or the acryloyloxy group are respectively joined to the silicon atom; and

S2, coating the organic-inorganic hybrid polymer on a surface of the lithium metal plate 102 to form a protective layer 104.

The surface of the lithium metal plate 102 can be cleaned before the coating to remove an impurity and increase an adhesion force between the protective layer 104 and the lithium metal plate 102. In one embodiment, a hydroxyl group is formed by polishing the surface of the lithium metal plate 102 by using polymers such as polyolefin or polyester.

The organic-inorganic hybrid polymer can be prepared by the steps of:

S11, providing a silicon-oxygen organic monomer comprising a silicon atom, a methacryloyloxy group or an acryloyloxy group, and at least two alkoxy groups, and the alkoxy groups and the methacryloyloxy group or the acryloyloxy group are respectively joined to the silicon atom; and

S12, polymerizing the silicon-oxygen organic monomer.

In S11, the silicon-oxygen organic monomer comprises the methacryloyloxy group (H₂C═C(CH₃)COO—) or the acryloyloxy group (H₂C═CHCOO—). The silicon-oxygen organic monomer also comprises the alkoxy groups (—OR₁). The methacryloyloxy group or the acryloyloxy group and the alkoxy groups are respectively connected to the silicon atom to form a silicon-oxygen (Si—O) group in the silicon-oxygen organic monomer. The alkoxy groups can be the same or different from each other. In one embodiment, the silicon-oxygen organic monomer comprises —Si(OR₁)ₓ(R₂)_{y}, wherein x+y=3, x≧2, y≧0. In one embodiment, x=3, y=0. R₂ can be a hydrocarbon group or hydrogen. In one embodiment, R₂ is an alkyl group, such as —CH₃ or —C₂H₅. R₁ can be an alkyl group, such as —CH₃ or —C₂H₅. The methacryloyloxy group or the acryloyloxy group can be joined to the —Si(OR₁)ₓ(R₂)_{y} through an organic group, such as alkanes, alkenes, alkynes, cycloalkanes, or aromatic groups.

The silicon-oxygen organic monomer can be represented by a formula:

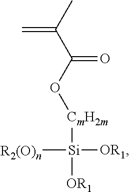

wherein n=0 or 1, m is 1 to 5 such as 3.

The silicon-oxygen organic monomer can be at least one of γ-(triethoxysilyl)propyl methacrylate, γ-(trimethoxysilyl)propyl methacrylate, γ-methacryloxypropylmethyldimethoxysilane, (diethoxymethylsilyl)propyl methacrylate, γ-acryloxypropyltriethoxysilane, γ-acryloxypropyltrimethoxysilane, γ-acryloxypropylmethyldimethoxysilane, acryloxypropylmethyldiethoxysilane, and acryloxypropylmethyldimethoxysilane.

In S12, the polymerizing comprises:

S121, uniformly mixing a free radical initiator and the silicon-oxygen organic monomer to form a homogeneous solution;

S122, stirring the homogeneous solution at a heating condition to polymerize the silicon-oxygen organic monomer to form the organic-inorganic hybrid polymer.

In S121, the initiator is capable of initiating the polymerization between the silicon-oxygen organic monomer. The initiator can be azobisisobutyronitrile (AIBN) azobisdimethylvaleronitrile (AIVN) or benzoyl peroxide (BPO). In S122, the heating temperature can be 60° C. to 90° C. The method can further comprise a step of purifying the organic-inorganic hybrid polymer after the polymerization is completed. The purification can be a dissolution-precipitation-washing method, and in one embodiment, the method comprises:

S123, adding a first solvent to the product obtained from the polymerization to form a mixed solution, wherein the first solvent is miscible with the organic-inorganic hybrid polymer;

S124, gradually adding the mixed solution to a second solvent to precipitate the organic-inorganic hybrid polymer; and

S125, separating the organic-inorganic hybrid polymer from the solvents.

In S123, the concentration of the mixed solution is adjusted so that the mixed solution becomes a flowable homogeneous liquid. In S124, the mixed solution can be added drop by drop to the second solvent to have the organic-inorganic hybrid polymer precipitated in the solvents. Then the organic-inorganic hybrid polymer can be washed.

The S123 to S124 can be repeated a plurality of times to obtain pure organic-inorganic hybrid polymer.

The first solvent is miscible with the organic-inorganic hybrid polymer. The first solvent can be tetrahydrofuran or acetone. The organic-inorganic hybrid polymer has a low solubility in the second solvent, such that the organic-inorganic hybrid polymer can be precipitated. The second solvent can be at least one of water, ethanol, and methanol. In one embodiment, the second solvent is a mixed solvent of water and methanol.

In S125, the separating can be carried out by filtrating and drying.

The organic-inorganic hybrid polymer has a good viscosity, so that it is easy to form a uniform and continuous protective layer bonded to the surface of the lithium metal plate, thereby preventing the forming of the lithium dendrites on the surface of the lithium metal plate.

In S2, the method for the coating of the organic-inorganic hybrid polymer is not limited. In one embodiment, the coating can be applied in a liquid way, such as comprising:

S21, dissolving the organic-inorganic hybrid polymer in an organic solvent to form a polymer solution; and

S22, coating the polymer solution onto the surface of the lithium metal plate 102 to form the protective layer 104.

In S21, the organic-inorganic hybrid polymer can be dissolved in the organic solvent to form the polymer solution. The organic solvent can be tetrahydrofuran, acetone, or an electrolyte solution. The organic solvent can be a nonaqueous electrolyte solution used in a lithium rechargeable battery, such that the protective layer 104 does not need to be dried after being formed on the surface of the lithium metal plate 102, and the lithium metal electrode 100 can be directly assembled in the lithium rechargeable battery. The nonaqueous electrolyte solution comprises a solvent and a salt dissolved in the solvent, and the solvent can be one or more of cyclic carbonates, chain carbonates, cyclic ethers, chain ethers, nitriles, and amides, such as ethylene carbonate (EC), propylene carbonate, diethyl carbonate, dimethyl carbonate (DEC), ethylmethyl carbonate (EMC), methyl acetate, ethyl acetate, propyl acetate, methyl propionate, ethyl propionate, γ-butyrolactone, tetrahydrofuran, 1,2-dimethoxyethane, acetonitrile, and dimethylformamide. The lithium salt can be one or more of lithium hexafluorophosphate (LiPF₆), lithium tetrafluoroborate (LiBF₄), lithium trifluoromethanesulfonate (LiCF₃SO₃), lithium hexafluoroarsenate (LiAsF₆), and lithium bis(oxalate)borate (LiBOB).

In one embodiment, the organic solvent is the nonaqueous electrolyte solution, wherein the nonaqueous electrolytic solution is a mixture of EC, DEC, and EMC in which LiPF₆ is dissolved, and a volume ratio of EC, DEC and EMC is 1:1:1.

In S22, the coating can be carried out by immersing the lithium metal plate 102 in the organic solvent for a period of time and then removing from the organic solvent. The coating can form a nanosized continuous-phase protective film on the surface of the lithium metal plate 102.

One embodiment of a lithium rechargeable battery comprises a cathode electrode, an anode electrode, a separator, and a nonaqueous electrolyte solution, wherein the separator is disposed between the cathode electrode and the anode electrode, and the anode electrode is the lithium metal electrode 100.

The cathode electrode can comprise a cathode current collector and a cathode material layer. The cathode material layer comprises a cathode active material, and can further optionally comprise a conductive agent and a binder. The conductive agent and the binder can be uniformly mixed with the cathode active material. The cathode active material can be, for example, one or more of lithium cobalt oxide, spinel type lithium manganese oxide, layered type lithium manganese oxide, lithium iron phosphate, lithium nickel oxide, lithium nickel manganese oxide, lithium nickel cobalt manganese oxide, and organic and inorganic sulfides.

### EXAMPLE 1

The azobisisobutyronitrile (AIBN) is dissolved in γ-(triethoxysilyl)propyl methacrylate and stirred at 80° C. to have a polymerization reaction. The product of the polymerization reaction is diluted with tetrahydrofuran and precipitated in a mixed solvent of methanol and water for three times to extract the machine-inorganic hybrid polymer. The extracted organic-inorganic hybrid polymer is dissolved in an electrolyte solution (EC:DEC:EMC=1:1:1, 1M LiPF₆) to form a 5 wt % polymer solution. A polished lithium metal plate is immersed in the polymer solution for about 0.5 hours, taken out, and assembled with a cathode electrode plate having lithium cobalt oxide and a cel-2325 separator to form a lithium rechargeable battery A.

### Comparative Example

A pure lithium metal plate (e.g., without the protective layer) as the anode electrode is assembled into a lithium rechargeable battery B in the same other conditions.

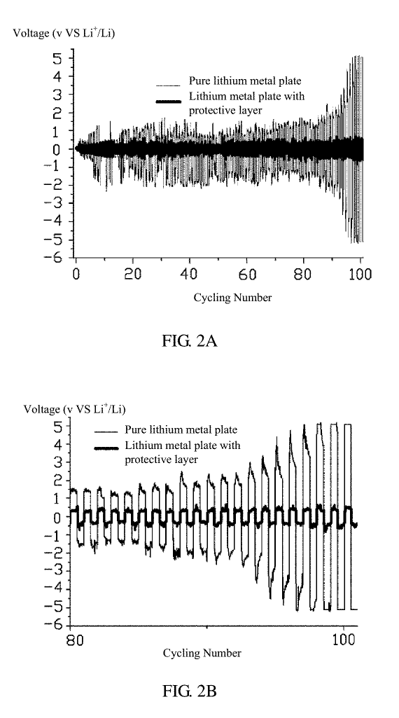

The lithium rechargeable battery A and the lithium rechargeable battery B are electrochemically cycled to compare the influence of the lithium metal electrode and the pure lithium metal plate on the electrochemical performances. Referring to FIG. 2A and FIG. 2B, it can be seen that the polarization of the lithium rechargeable battery A is remarkably reduced in the charge and discharge.

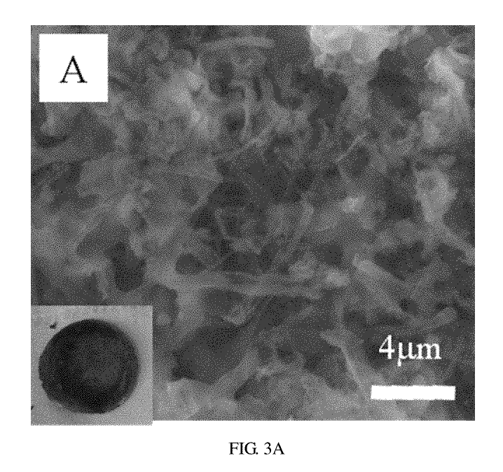

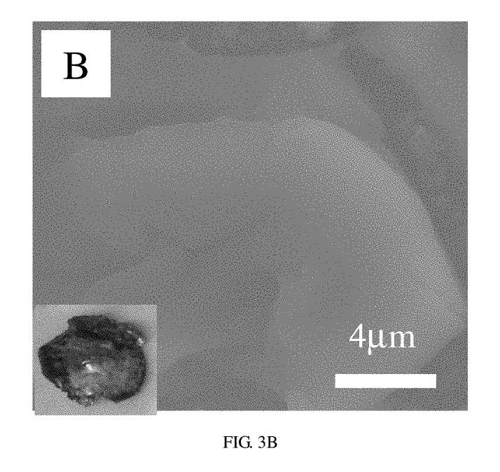

Referring to FIG. 3A and FIG. 3B, after the electrochemical cycling of the batteries, the anode electrodes are taken out and examined by SEM. It can be seen that the surface of the pure lithium metal plate of the Comparative Example has significant dendrites, and the surface of the lithium metal electrode of the Example 1 is smooth with substantially no lithium dendrite.

The present disclosure has the lithium metal plate coated by the protective layer to suppress the producing of the lithium dendrites and reduce side effects occurred on the electrode surface, greatly improving the electrochemical cycling stability of the battery.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A lithium metal electrode comprising:
a lithium metal plate; and
a protective layer coated on a surface of the lithium metal plate,
wherein the protective layer comprises an organic-inorganic hybrid polymer comprising a repeating unit, the repeating unit comprises a silicon atom, a methacryloyloxy group or an acryloyloxy group, and at least two alkoxy groups, the alkoxy groups and the methacryloyloxy group or the acryloyloxy group are respectively joined to the silicon atom.

2. The lithium metal electrode of claim 1, wherein an amount of the repeating unit in the organic-inorganic hybrid polymer is in a range from about 40 to about 5000.

3. The lithium metal electrode of claim 1, wherein the organic-inorganic hybrid polymer is selected from the group consisting of poly-γ-(triethoxysilyl)propyl methacrylate, poly-γ-(trimethoxysilyl)propyl methacrylate, poly-γ-methacryloxypropylmethyldimethoxysilane, poly-(diethoxymethylsilyl)propyl methacrylate, poly-γ-acryloxypropyltriethoxysilane, poly-γ-acryloxypropyltrimethoxysilane, poly-γ-acryloxypropylmethyldimethoxysilane, poly-acryloxypropylmethyldiethoxysilane, poly-acryloxypropylmethyldimethoxysilane, and combinations thereof.

4. The lithium metal electrode of claim 1, wherein the organic-inorganic hybrid polymer is a polymerization product of a silicon-oxygen organic monomer, and the silicon-oxygen organic monomer comprises —Si(OR₁)ₓ(R₂)_{y}, wherein x+y=3, x≧2, y≧0.

5. The lithium metal electrode of claim 4, wherein the R₂ is a hydrocarbon group or hydrogen, and the R₁ is an alkyl group.

6. The lithium metal electrode of claim 4, wherein the silicon-oxygen organic monomer is represented by 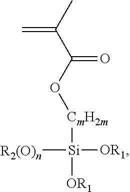
n is 0 or 1, and m is 1 to 5.

7. A method for preparing a lithium metal electrode, the method comprising:
providing a lithium metal plate and an organic-inorganic hybrid polymer comprising a repeating unit, the repeating unit comprising a silicon atom, a methacryloyloxy group or an acryloyloxy group, and at least two alkoxy groups, and the alkoxy groups and the methacryloyloxy group or the acryloyloxy group being respectively joined to the silicon atom; and
coating the organic-inorganic hybrid polymer on a surface of the lithium metal plate to form a protective layer.

8. The method of claim 7, further comprising:
polishing the surface of the lithium metal plate by using polyolefin or polyester to form a hydroxyl group.

9. The method of claim 7, wherein the organic-inorganic hybrid polymer is formed by:
providing a silicon-oxygen organic monomer; and
polymerizing the silicon-oxygen organic monomer.

10. The method of claim 9, wherein the silicon-oxygen organic monomer comprises —Si(OR₁)ₓ(R₂)_{y}, wherein x+y=3, x≧2, and y≧0.

11. The method of claim 10, wherein the R₂ is a hydrocarbon group or hydrogen.

12. The method of claim 9, wherein the silicon-oxygen organic monomer comprises an organic group, the methacryloyloxy group or the acryloyloxy group is joined to the —Si(OR₁)ₓ(R₂)_{y} through an organic group, and the organic group is selected from the group consisting of alkanes, alkenes, alkynes, cycloalkanes, aromatic groups, and combinations thereof.

13. The method of claim 9, wherein the silicon-oxygen organic monomer is represented by 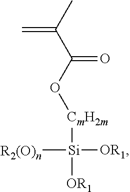
n is 0 or 1, and m is 1 to 5.

14. The method of claim 9, wherein the silicon-oxygen organic monomer is selected from the group consisting of γ-(triethoxysilyl)propyl methacrylate, γ-(trimethoxysilyl)propyl methacrylate, γ-methacryloxypropylmethyldimethoxysilane, (diethoxymethylsilyl)propyl methacrylate, γ-acryloxypropyltriethoxysilane, γ-acryloxypropyltrimethoxysilane, γ-acryloxypropylmethyldimethoxysilane, acryloxypropylmethyldiethoxysilane, acryloxypropylmethyldimethoxysilane, and combinations thereof.

15. The method of claim 7, wherein the coating the organic-inorganic hybrid polymer further comprises:
dissolving the organic-inorganic hybrid polymer in a nonaqueous electrolyte solution to form a polymer solution; and
coating the polymer solution on the surface of the lithium metal plate to form the protective layer.

16. The method of claim 15, wherein the nonaqueous electrolyte solution comprises a solvent and a salt dissolved in the solvent; the solvent is selected from the group consisting of ethylene carbonate, propylene carbonate, diethyl carbonate, dimethyl carbonate, ethylmethyl carbonate, methyl acetate, ethyl acetate, propyl acetate, methyl propionate, ethyl propionate, γ-butyrolactone, tetrahydrofuran, 1,2-dimethoxyethane, acetonitrile, dimethylformamide, and combinations thereof; and the lithium salt is selected from the group consisting of lithium hexafluorophosphate, lithium tetrafluoroborate, lithium trifluoromethanesulfonate, lithium hexafluoroarsenate, lithium bis(oxalate)borate, and combinations thereof.

17. A lithium ion battery comprising:
a cathode electrode;
an anode electrode comprising
a lithium metal plate; and
a protective layer coated on a surface of the lithium metal plate;
a nonaqueous electrolyte solution; and
a separator disposed between the cathode electrode and the anode electrode;
wherein the protective layer comprises an organic-inorganic hybrid polymer comprising a repeating unit; the repeating unit comprises a silicon atom, a methacryloyloxy group or an acryloyloxy group, and at least two alkoxy groups; the at least two alkoxy groups and the methacryloyloxy group or the acryloyloxy group are respectively joined to the silicon atom.
